(19) United States
(12) Patent Application Publication
(10) Pub. No.: US 2025/0303253 A1
(43) Pub. Date: Oct. 2, 2025

(54) THREE-SECTION VARIABLE ELECTRONIC HOCKEY PUCK CONTROLLER

(71) Applicant: POTENT SPORTS&TECH CO., LTD, Nantong (CN)

(72) Inventors: Shiliang XIE, Nantong (CN); Yong ZHANG, Nantong (CN)

(73) Assignee: POTENT SPORTS&TECH CO., LTD, Nantong (CN)

(21) Appl. No.: 18/674,724

(22) Filed: May 24, 2024

(30) Foreign Application Priority Data
Mar. 29, 2024 (CN) 2024103768346

(51) Int. Cl. A63B 69/00; A63B 71/06; H05B 45/10; H05B 47/115

(52) U.S. Cl. CPC A63B 69/0026; A63B 71/0605; A63B 71/0669; H05B 45/10; H05B 47/115; A63B 2225/74

(57) ABSTRACT

Disclosed is a three-section variable electronic hockey puck controller, including three-section slats hinged end to end, where supporting assemblies are arranged below the three-section slats at head and tail ends; the hockey puck controller also includes an LED light-emitting assembly mounted on a surface of each slat, one Hall sensing assembly mounted inside each slat, a motion assembly mounted inside each supporting assembly; and the hockey puck controller further includes a controller placed inside the hockey puck controller, where the controller controls the LED light-emitting assembly through an LED lamp driver, and the motion assembly is controlled by a motor driver. When the hockey puck continuously passes through the slats for many consecutive times, and scores are given, effective training will be identified, in which case, advancement will be performed and a higher level of training difficulty will be started; otherwise, training under the initial mode will continue.

### CROSS-REFERENCE TO RELATED APPLICATIONS

This application claims the benefit of priority from Chinese Patent Application No. 2024103768346 filed on Mar. 29, 2024, the contents of which are hereby incorporated by reference in their entirety.

### TECHNICAL FIELD

The present disclosure relates to the technical field of training equipment, and particularly relates to a three-section variable electronic hockey puck controller.

### BACKGROUND

Essential basic techniques of ice hockey are hockey puck control, passing, shooting, and skating, which are real-time application of techniques on points and surfaces by players during an ice hockey game, and are means to execute tactical coordination.

Hockey puck control and dribbling techniques are the most fundamental and crucial techniques for hockey puck possession. Hockey puck control and dribbling techniques are the most fundamental and crucial techniques for hockey puck possession, which are usually used during face-off, passing, deceiving goalkeepers, preparing to pass, and shooting. Therefore, it is necessary to develop a device with hockey puck control training techniques capable of training athletes in hockey puck control techniques and ball control reaction thinking, so that athletes can gradually improve their hockey puck control abilities under digital scenario-based training methods, have an objective understanding of their respective hockey puck control levels, and remind the athletes to seize changes of passing and shooting, such that goals can be set clearly, and techniques and abilities of the athletes are gradually improved.

In the Chinese Patent Application numbered CN202010555518.7, a training device for hockey puck control techniques of ice hockey is disclosed, which adopts Hall elements and electromagnetic induction components to sense whether the hockey puck passes under cross members, and accurate counting can be performed through a counter.

However, the above patent does not disclose a structure that the training device can adjust training difficulty based on the athlete's ability to control the puck.

Therefore, it is necessary to develop a three-section variable electronic hockey puck controller capable of automatically adjust corresponding difficulty levels according to the hockey puck control and goal-passing abilities of the athletes.

### SUMMARY

An objective of the present disclosure is to provide a three-section variable electronic hockey puck controller, such that the hockey puck controller can intelligently switch training modes according to a level of an athlete.

In order to achieve the above objective, the present disclosure provides the following technical solution:
a three-section variable electronic hockey puck controller includes three-section slats hinged end to end, where supporting assemblies are arranged below the three-section slats at head and tail ends; it also includes an LED light-emitting assembly mounted on a surface of each slat, one Hall sensing assembly mounted inside each slat, a motion assembly mounted inside each supporting assembly; and it further includes a controller placed inside the hockey puck controller, where the controller controls the LED light-emitting assembly through an LED lamp driver, and the motion assembly is controlled by a motor driver;
the LED light-emitting assembly includes three LED lamp, that is, a first LED lamp, a second LED lamp and a third LED lamp, and the LED lamp driver is configured to control the three LED lamps to be lighted off or up;
the Hall sensing assembly corresponds to the LED light-emitting assembly and is configured to sense whether a hockey puck passes under the slats, collect data passing through the slats, and transmit the data to the controller; and
the motion assembly includes motors placed inside each supporting assembly on the slats at the head and tail ends, the motors include a first motor and a second motor, respectively, and the motor driver is configured to control forward and reverse rotation of the first motor and the second motor.

The hockey puck controller further includes a score display nixie tube, and the score display nixie tube is mounted on one of the slats and is connected to the Hall sensing assembly; and the score display nixie tube is configured to make statistics and display a number of hockey pucks passing through the slats.

One of the support assemblies is further provided with an infrared sensor, which is connected to the motor placed insider the support assembly, and is configured to detect a folded state of the slats.

The hockey puck controller further includes a charging indicator light, an on-off key, and a charging port, where the charging indicator light, the on-off key, and the charging port are all fixed on one of the support assemblies, and are all electrically connected to the controller.

Convex sliding sheets are arranged on a bottom of the supporting assembly.

The controller further includes a Bluetooth module, where the Bluetooth module is connected to an APP on a mobile terminal.

The three-section variable electronic hockey puck controller includes the following motion steps:
S1. starting the three-section variable electronic hockey puck controller through the on-off key, such that the controller is in a working state;
S2: after being turned on, the hockey puck controller uses the infrared sensor to detect a folding angle of the three-section slats, the information is transmitted to the controller, forward and reverse rotation of the first motor or the second motor is started through the motor driver connected to the controller, and a photoelectric encoder of the first motor or the second motor feeds back the control, such that the slats are rotated into a straight line;
S3: when any LED lamp on the slats lights on, the hockey puck passes through the slats of the lamp lighted up, the corresponding Hall sensing assembly senses the puck, and transmits data to the score display nixie tube, which displays a score +1, and at the same time, the data is transmitted to the controller, and the LED lamp driver is configured to drive the LED light-emitting assembly to switch the LED lamps; and
S4: when the hockey puck continuously passes through the slats for many times and successfully gets scores according to the setting, the hockey puck controller will switch to a difficulty mode, and the slats on both sides are continuously varied; otherwise, when no score is obtained, the hockey puck controller will maintain a simple mode, and the slats automatically retract and restore to the original shapes after a countdown ends.

After the three-section variable electronic hockey puck controller is started through the on-off key, the controller inside the hockey puck controller is connected to the mobile terminal through the Bluetooth module, and an APP interface on the mobile phone is adapted to a motion mode of the athlete's own level by selecting the same.

Compared with the prior art, the present disclosure has the following beneficial effects:
1. When the hockey puck continuously passes through the slats for many consecutive times, and scores are given, effective training will be identified, in which case, advancement will be performed and a higher level of training difficulty will be started, which increases the training difficulty of the puck; otherwise, training under the initial mode will continue, the training mode will change intelligently, and different difficulties are matched according to different abilities, and the fun of practicing the ice hockey is improved.
2. After the three-section variable electronic hockey puck controller is in communication connection with the APP on the mobile terminal through the controller and the Bluetooth module, various training data of the athlete are collected and recorded in real time, which can help the player understand his/her training progress and technical weaknesses, so as to make targeted adjustments and improvements.

### BRIEF DESCRIPTION OF THE DRAWINGS

FIG. 1 is an overall diagram of a three-section variable electronic hockey puck controller according to the present disclosure.

FIG. 2 is an expanded diagram of a three-section variable electronic hockey puck controller according to the present disclosure.

FIG. 3 is a schematic diagram of a supporting assembly of a three-section variable electronic hockey puck controller according to the present disclosure.

FIG. 4 is a schematic diagram of convex sliding sheets of a three-section variable electronic hockey puck controller according to the present disclosure.

FIG. 5 is a schematic diagram of a framework of a three-section variable electronic hockey puck controller according to the present disclosure.

Reference numerals in the accompanying drawings: 1. slat; 2. supporting assembly; 21. first motor; 22. second motor; 3. LED light-emitting assembly; 31. first LED lamp; 32. second LED lamp; 33. third LED lamp; 34. LED driver; 4. Hall sensing assembly; 5. controller; 6. motor driver; 7. score display nixie tube; 8. infrared sensor; 9. charging indicator light; 10. on-off key; 11. charging port; 12. Bluetooth module; and 13. convex sliding sheet.

### DETAILED DESCRIPTIONS OF THE EMBODIMENTS

The technical solutions of embodiments of the present disclosure will be described below clearly and comprehensively in conjunction with accompanying drawings of the embodiments of the present disclosure. Apparently, the embodiments described are merely some embodiments rather than all embodiments of the present disclosure. All the other embodiments obtained by those of ordinary skill in the art based on the embodiments in the present disclosure without creative efforts shall fall within the scope of protection of the present disclosure.

### Embodiment 1

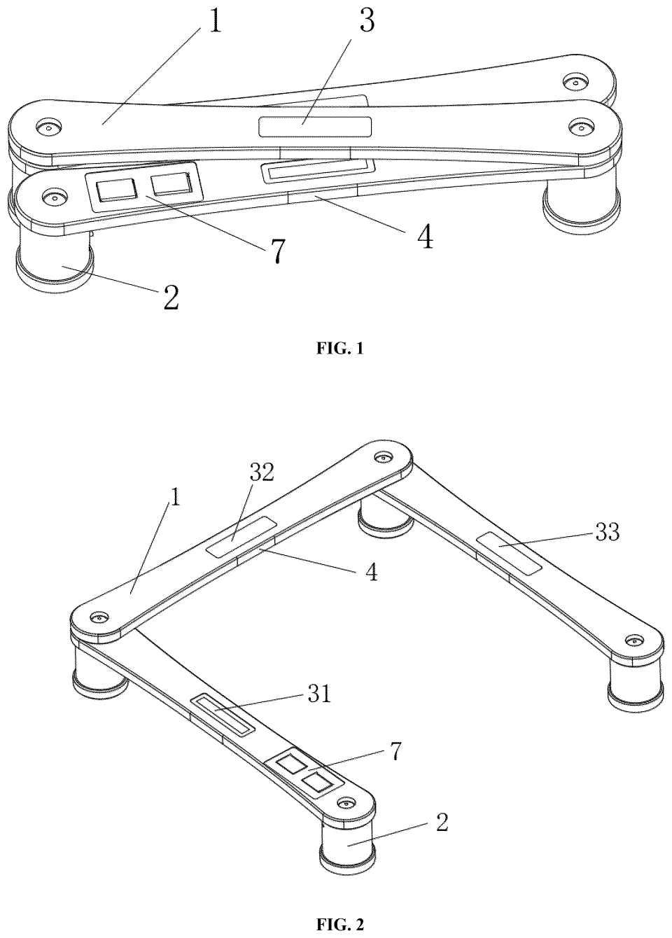

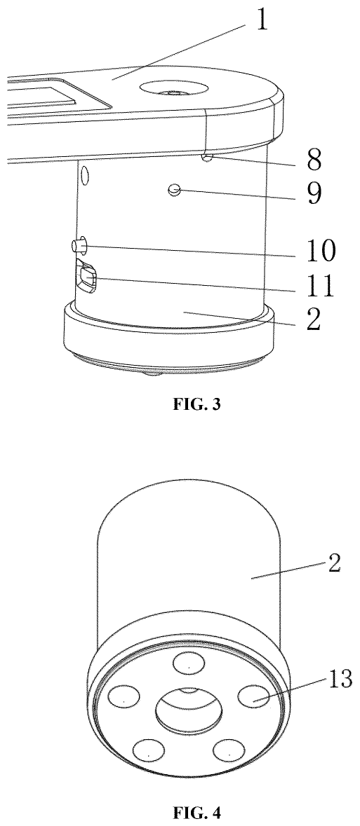

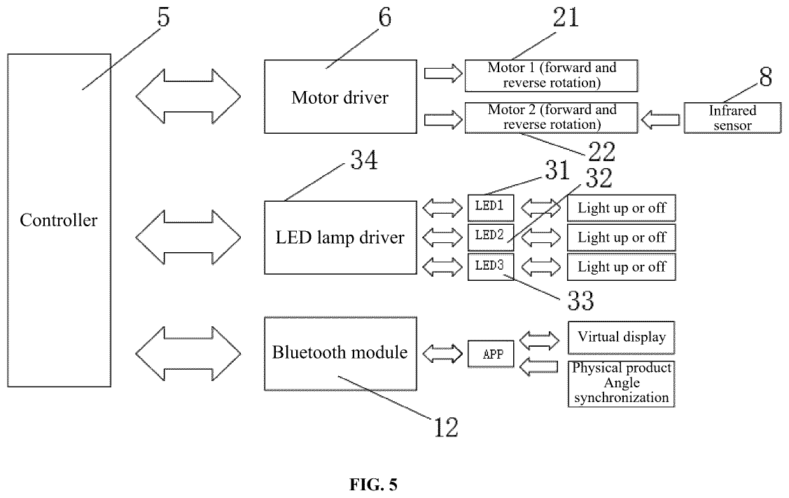

With reference to FIGS. 1-5, the present disclosure provides one embodiment:
a three-section variable electronic hockey puck controller includes three-section slats 1 hinged end to end, where supporting assemblies 2 are arranged below the three-section slats 1 at head and tail ends; it also includes an LED light-emitting assembly 3 mounted on a surface of each slat 1, one Hall sensing assembly 4 mounted inside each slat 1, a motion assembly mounted inside each supporting assembly 2; and it further includes a controller 5 placed inside the hockey puck controller, where the controller 5 controls the LED light-emitting assembly 3 through an LED lamp driver 34, and the motion assembly is controlled by a motor driver 6;
the LED light-emitting assembly 3 includes three LED lamps, that is, a first LED lamp 31, a second LED lamp 32 and a third LED lamp 33, and the LED lamp driver 34 is configured to control the three LED lamps to be lighted off or on;
the Hall sensing assembly 4 corresponds to the LED light-emitting assembly 3 and is configured to sense whether a hockey puck passes under the slats 1, collect data of the hockey puck passing through the slats 1, and transmit the data to the controller; and
the motion assembly includes motors placed inside each supporting assembly (2) on the slats at the head and tail ends, the motors include a first motor 21 and a second motor 22, respectively, and the motor driver 6 is configured to control forward and reverse rotation of the first motor 21 and the second motor 22.

In a structure of the slats of the three-section variable electronic hockey puck controller, the three-section slats 1 hinged end to end are arranged, the slat 1 located in the middle is overlapped on the slats 1 at the head and tail ends, such that the three-section hockey puck controller overlapped at the head and tail ends thereof, the slats are movably connected through bolts, and the supporting assemblies 2 are movably mounted under the slats 1 overlapped at the head and tail ends through bolts;
the surfaces of the three-section slats 1 are respectively provided with the first LED lamp 31, the second LED lamp 32 and the third LED lamp 33, which correspond to the Hall sensing assembly 4, the Hall sensing assembly 4 is a Hall sensor, each LED lamp corresponds to one Hall sensor, and the controller 5 controls the LED light-emitting assembly 3 and the Hall sensing assembly 4;
therefore, when the hockey puck passes under the slats 1, an electromagnetic induction member inside the hockey puck triggers induction between the electromagnetic induction member and the Hall sensing assembly 4, the Hall sensing assembly 4 transmits a signal to the controller 5, and after receiving the signal, the controller 5 transmits a lamp change signal to the LED lamps through the LED lamp driver 34, such that the LED lamp under which the hockey puck passes is controlled to be lighted off, and another LED lamp is lighted up; and
the first motor 21 and the second motor 22 are arranged inside the supporting assembly 2 located on an outer side, and the controller 5 and the motor driver 6 are configured to drive the first motor 21 and the second motor 22 to rotate forward and reverse to drive continuous variation of the slats 1, such that a training effect that the hockey puck passes under the slats 1 is achieved.

The hockey puck controller further includes a score display nixie tube 7, and the score display nixie tube 7 is mounted on one of the slats 1 and is connected to the Hall sensing assembly 4; and the score display nixie tube 7 is configured to make statistics and display a number of hockey pucks, and give scores for the number of hockey pucks passing under the slats 1, so as to facilitate the statistics of training data.

One of the support assemblies 2 is further provided with an infrared sensor 8, which is connected to the motor placed insider the support assembly 2, and is configured to detect a folded state of the slats 1, and the three-section slats of the hockey puck controller can be restored to their original pattern each time when the hockey puck controller is started by using the infrared sensor 8 and forward and reverse rotation of the motors.

The controller 5 controls the LED light-emitting assembly 3 through the LED lamp driver 34, and the motion assembly is controlled by the motor driver 6, such that the first motor 21, the second motor 22, and the infrared sensor 8 control the standardization and complexity of the variation of the slats 1, technical level and reaction ability of a user can be analyzed in real time, difficulty can be automatically identified and adjusted, and suitable training courses are recommended. Therefore, the hockey puck controller provided in the present disclosure is a great innovation capable of performing evaluation of adaptive technical level and providing personalized training courses.

The hockey puck controller further includes a charging indicator light 9, an on-off key 10, and a charging port 11, where the charging indicator light 9, the on-off key 10, and the charging port 11 are all fixed on one of the support assemblies 2, and are all electrically connected to the controller 5, the charging indicator light 9 is configured to indicate a charging status, the on-off key 10 is configured to turn on or turn off the hockey puck controller, and the charging port 11 is configured to be externally connected to a charging cable to charge the hockey puck controller.

Convex sliding sheets 13 are arranged on a bottom of the supporting assembly 2, and are configured to reduce sliding friction between the supporting assembly 2 and a ground, thereby reducing sliding losses.

The controller 5 further includes a Bluetooth module 12, where the Bluetooth module 12 is connected to an APP on a mobile terminal, the mobile terminal includes a mobile phone or other smart screen projection devices. The APP developed in conjunction with a training robot provides a virtual reality training scene, allowing the user to achieve highly consistent integrated consciousness training through vision and action separation by using the mobile phone and other smart screen projection devices; and a virtual robot in the APP has a variation action, identification and interaction reactions consistent with that of a real robot, and the user can achieve an advanced training effect of eye-hand coordination and separation through interactive training of real and virtual scenes. This innovation makes the training of the user closer to competition scenes, greatly improving the training efficiency of the user and meeting the experience feeling.

The three-section variable electronic hockey puck controller includes the following motion steps:
S1. start the three-section variable electronic hockey puck controller through the on-off key 10, such that the controller 5 is in a working state;
S2: after being turned on, the hockey puck controller uses the infrared sensor 8 to detect a folding angle of the three-section slats, the information is transmitted to the controller 5, forward and reverse rotation of the first motor 21 or the second motor 22 is started through the motor driver 6 connected to the controller 5, and a photoelectric encoder of the first motor 21 or the second motor 22 feeds back the control, such that the slats 1 are rotated into a straight line;
S3: when any LED lamp on the slats 1 lights on, the hockey puck passes through the slats 1 of the lamp lighted up, the corresponding Hall sensing assembly 4 senses the puck, and transmits data to the score display nixie tube 7, which displays a score +1, and at the same time, the data is transmitted to the controller 5, and the LED lamp driver 34 is configured to drive the LED light-emitting assembly 3 to switch the LED lamps; and
S4: when the hockey puck continuously passes through the slats 1 for many times and successfully gets scores according to the setting, the hockey puck controller will switch to a difficulty mode, and the slats 1 on both sides are continuously varied; otherwise, when no score is obtained, the hockey puck controller will maintain a simple mode, and the slats automatically retract and restore to the original shapes after a countdown ends.

In the setting of the three-section variable electronic hockey puck controller, the countdown is set to 45 s, and the score is set to a mode of 1/2/3 scores, and therefore, a novice mode will be started after 6 scores are obtained for three consecutive times;
when 6 scores are not obtained for three consecutive times, the hockey puck controller will return to an initial mode, the slats are driven to vary through the first motor 21 or the second motor 22, and the variation switches among an L-type, a 7-type and a straight-line type, until the novice mode is started again after 6 scores are obtained for three consecutive times; and
the difficulty mode will be started after cumulative score under the novice mode exceeds 20 scores, a display frequency of the corresponding LED lamp is adjusted from 3 s to 2 s, and the difficulty of the variation also increases the complexity.

The situation that the hockey puck continuously passes through the slats 1 for many consecutive times, and scores are given, effective training is determined, in which case, advance will be performed and a higher level of training difficulty will be started, which increases the training difficulty of the puck; otherwise, training under the initial mode will continue, the training mode will change intelligently, and different difficulties are matched according to different abilities, and the fun of practicing the ice hockey is improved.

### Embodiment 2

After the three-section variable electronic hockey puck controller is started through the on-off key 10, the controller 5 inside the hockey puck controller is connected to the mobile terminal through the Bluetooth module 12, where the mobile terminal includes a mobile phone terminal and a computer mobile terminal, and an APP interface on the mobile phone is adapted to a motion mode of the level of the athlete by selecting the same.

The mode thereof includes a specified mode, a random mode, and an intelligent level mode.

After the APP on the mobile terminal is in communication connection with the three-section variable electronic hockey puck controller, various training data of the athlete, including a hockey puck passing speed, single scores, an average score, a training frequency, a cumulative number of different modes, and the like, are collected and recorded in real time, and the collected data is analyzed to generate training reports and icons to help the athlete obtain a understanding of his/her own training progress and technical weaknesses, such that more targeted adjustment and improvement can be performed, and training results and an improvement direction of the athlete can be displayed; and the training reports and icons can represent the data in a in a visual manner, such that the athlete can further gain an intuitive understanding of his/her own training situation, and corresponding adjustments and improvements can be made.

The APP on the mobile terminal can further generate a personalized training plan according to training goals and needs of the athlete, and has a training reminder function, such that the athlete can arrange the training plan according to his/her own schedule and ability, and perform training in a timely manner through the reminding function, so as to maintain continuity and effectiveness of training.

The APP on the mobile terminal also provides a social and competitive communication platform, allowing athletes to interact and communicate with one another, share their training results and experience, participate in athlete ranking and competition, complete and play against other athletes, stimulate competitive consciousness and motivation of the athletes, and improve training achievements and effects.

What it claimed is:

1. A three-section variable electronic hockey puck controller, comprising three-section slats hinged end to end, wherein supporting assemblies are arranged below the three-section slats at head and tail ends; also comprising an LED light-emitting assembly mounted on a surface of each slat, one Hall sensing assembly mounted inside each slat, a motion assembly mounted inside each supporting assembly; and further comprising a controller placed inside the hockey puck controller, wherein the controller controls the LED light-emitting assembly through an LED lamp driver, and the motion assembly is controlled by a motor driver;
the LED light-emitting assembly comprises three LED lamps, that is, a first LED lamp, a second LED lamp and a third LED lamp, and the LED lamp driver is configured to control the three LED lamps to be lighted off or on;
the Hall sensing assembly corresponds to the LED light-emitting assembly and is configured to sense whether a hockey puck passes under the slats, collect data passing through the slats, and transmit the data to the controller; and
the motion assembly comprises motors placed inside each supporting assembly on the slats at the head and tail ends, the motors comprise a first motor and a second motor, respectively, and the motor driver is configured to control forward and reverse rotation of the first motor and the second motor.

2. The three-section variable electronic hockey puck controller according to claim 1, wherein the hockey puck controller further comprises a score display nixie tube, and the score display nixie tube is mounted on one of the slats and is connected to the Hall sensing assembly; and the score display nixie tube is configured to make statistics and display a number of hockey pucks passing through the slats.

3. The three-section variable electronic hockey puck controller according to claim 2, wherein one of the support assemblies is further provided with an infrared sensor, which is connected to the motor placed insider the support assembly, and is configured to detect a folded state of the slats.

4. The three-section variable electronic hockey puck controller according to claim 3, wherein the hockey puck controller further comprises a charging indicator light, an on-off key, and a charging port, wherein the charging indicator light, the on-off key, and the charging port are all fixed on one of the support assemblies, and are all electrically connected to the controller.

5. The three-section variable electronic hockey puck controller according to claim 3, wherein convex sliding sheets are arranged on a bottom of the supporting assembly.

6. The three-section variable electronic hockey puck controller according to claim 1, wherein the controller further comprises a Bluetooth module, wherein the Bluetooth module is connected to an APP on a mobile terminal.

7. The three-section variable electronic hockey puck controller according to claim 6, comprising the following motion steps:
S1. starting the three-section variable electronic hockey puck controller through the on-off key, such that the controller is in a working state;
S2: after being turned on, the hockey puck controller uses the infrared sensor to detect a folding angle of the three-section slats, the information is transmitted to the controller, forward and reverse rotation of the first motor or the second motor is started through the motor driver connected to the controller, and a photoelectric encoder of the first motor or the second motor feeds back the control, such that the slats are rotated into a straight line;
S3: when any LED lamp on the slats lights on, the hockey puck passes through the slats of the lamp lighted up, the corresponding Hall sensing assembly senses the puck, and transmits data to the score display nixie tube, which displays a score +1, and at the same time, the data is transmitted to the controller, and the LED lamp driver is configured to drive the LED light-emitting assembly to switch the LED lamps; and
S4: when the hockey puck continuously passes through the slats for many times and successfully gets scores according to the setting, the hockey puck controller will switch to a difficulty mode, and the slats on both sides are continuously varied; otherwise, when no score is obtained, the hockey puck controller will maintain a simple mode, and the slats automatically retract and restore to the original shapes after a countdown ends.

8. The three-section variable electronic hockey puck controller according to claim 7, wherein after the three-section variable electronic hockey puck controller is started through the on-off key, the controller inside the hockey puck controller is connected to the mobile terminal through the Bluetooth module, and an APP interface on the mobile phone is adapted to a motion mode of a level of the athlete by selecting the same.
